(19) United States
(12) Patent Application Publication
(10) Pub. No.: US 2025/0112231 A1
(43) Pub. Date: Apr. 3, 2025

(54) ELECTRODE ACTIVE MATERIAL, ELECTRODE MIXTURE, AND BATTERY

(71) Applicant: TOYOTA JIDOSHA KABUSHIKI KAISHA, Toyota-shi (JP)

(72) Inventors: Mitsutoshi Otaki, Susono-shi (JP); Jun Yoshida, Mishima-shi (JP); Masafumi Nose, Mishima-shi (JP)

(73) Assignee: TOYOTA JIDOSHA KABUSHIKI KAISHA, Toyota-shi (JP)

(21) Appl. No.: 18/754,431

(22) Filed: Jun. 26, 2024

(30) Foreign Application Priority Data
Sep. 28, 2023 (JP) 2023-168624

(51) Int. Cl. H01M 4/38; H01M 4/02; H01M 4/134; H01M 10/0562

(52) U.S. Cl. CPC H01M 4/386; H01M 4/134; H01M 10/0562; H01M 2004/027; H01M 2004/028; H01M 2300/0068

(57) ABSTRACT

In the present disclosure, the problem is solved by providing an electrode active material of which volume change due to charging and discharging is small. The electrode active material has a silicon-clathrate-II-type crystal phase. In the electrode active material, a five-membered ring size in the crystal phase is 3.752 Å or more and 3.780 Å or less.

### CROSS-REFERENCE TO RELATED APPLICATION

This application claims priority to Japanese Patent Application No. 2023-168624 filed on Sep. 28, 2023, incorporated herein by reference in its entirety.

### BACKGROUND

### 1. Technical Field

The present disclosure relates to an electrode active material, an electrode mixture, and a battery.

### 2. Description of Related Art

In recent years, batteries have been actively developed. For example, in the automotive industry, batteries used in a battery electric vehicle (BEV), a plug-in hybrid electric vehicle (PHEV), or a hybrid electric vehicle (HEV) have been under development. Silicon (Si) is known as an electrode active material used in batteries. For example, Japanese Unexamined Patent Application Publication No. 2021-158004 discloses an electrode active material that has a silicon-clathrate-II-type crystal phase and has a gap on the inside of a primary particle.

### SUMMARY

Si has a great theoretical capacity and is effective in terms of causing a battery to have a higher energy density. On the other hand, the volume change of Si at the time of charging and discharging is great. When the volume change at the time of charging and discharging is great, there are problems in that the function of an electrode active material easily decreases or the like when charging and discharging are repeated, for example.

The present disclosure has been made in view of the situation described above, and a main object thereof is to provide an electrode active material of which volume change due to charging and discharging is small.

As a result of intensive research in order to solve the problem described above, the inventors of the present disclosure have gained knowledge that the volume change at the time of charging and discharging is reduced when the electrode active material has a few diamond-type silicon crystal phases in addition to the silicon-clathrate-II-type crystal phases. At the same time, the inventors of the present disclosure have gained new knowledge that a difference is caused in the volume change at the time of charging and discharging even when the rates of the diamond-type silicon crystal phases are about the same in electrode active materials. As a result of detailed exploration regarding the reason why the difference is caused, the inventors of the present disclosure have found that the five-membered ring size of the silicon-clathrate-II-type crystal phase gives a great influence on the volume change at the time of charging and discharging, and have completed the disclosure below.
[1] An electrode active material having a silicon-clathrate-II-type crystal phase. In the electrode active material, a five-membered ring size in the crystal phase is 3.752 Å or more and 3.780 Å or less.
[2] In the electrode active material according to [1], the electrode active material may have a gap on the inside of a primary particle.
[3] An electrode mixture containing: an electrode active material according to [1] or [2]; and at least one of a conductive material or a binder.
[4] A battery, including: a positive-electrode layer; a negative-electrode layer; and an electrolyte layer disposed between the positive-electrode layer and the negative-electrode layer. In the battery, the positive-electrode layer or the negative-electrode layer contains the electrode mixture according to [3].
[5] In the battery according to [4], the electrolyte layer may contain a solid electrolyte.

In the present disclosure, an effect in which the electrode active material of which volume change due to charging and discharging is small is obtainable is exhibited.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic perspective view describing a crystal phase of Si;

FIG. 1B is a schematic perspective view describing a crystal phase of Si;

FIG. 2 is a schematic sectional view exemplifying a battery in the present disclosure; and

FIG. 3 is a result of volumetric expansion rates of batteries using electrode active materials obtained in Examples 1 to 5 and Comparative Examples 1 to 3.

### DETAILED DESCRIPTION OF EMBODIMENTS

An electrode active material, an electrode mixture, and a battery in the present disclosure are described in detail below.

### A. Electrode Active Material

The electrode active material in the present disclosure has a silicon-clathrate-II-type crystal phase. The five-membered ring size of the silicon-clathrate-II-type crystal phase is normally 3.752 Å or more and 3.780 Å or less.

According to the present disclosure, the five-membered ring size of the silicon-clathrate-II-type crystal phase is within a predetermined range, and hence an electrode active material of which volume change due to charging and discharging is small is obtained. As described above, Si has a great theoretical capacity and is effective in terms of causing the battery to have a higher energy density. On the other hand, the volume change of Si at the time of charging and discharging is great. When the volume change at the time of charging and discharging is great, there are problems in that the function of the electrode active material easily decreases or the like when charging and discharging are repeated, for example. Regarding problems as above, as a result of intensive research, the inventors of the present disclosure have gained knowledge that the volume change at the time of charging and discharging is reduced when the electrode active material has a few diamond-type silicon crystal phases in addition to silicon-clathrate-II-type crystal phases.

At the same time, the inventors of the present disclosure have gained new knowledge that a difference is caused in the volume change at the time of charging and discharging even when the rates of the diamond-type silicon crystal phases are about the same in electrode active materials. In other words, new knowledge that a phenomenon that cannot be described with only the rate of the diamond-type silicon crystal phases has been gained. Thus, as a result of detailed exploration regarding the reason the difference is caused, the inventors of the present disclosure have found that the five-membered ring size of the silicon-clathrate-II-type crystal phase gives a great influence on the volume change at the time of charging and discharging.

Specifically, the inventors of the present disclosure have found that the volume change at the time of charging and discharging can be reduced by adjusting the five-membered ring size of the silicon-clathrate-II-type crystal phase to be a predetermined range. The reason the volume change can be reduced is assumed to be because insertion and desorption of Li via the five-membered ring become smoother by adjusting the five-membered ring size to be a predetermined range. Meanwhile, when the five-membered ring size is too great or too small, it is assumed that volume change due to charging and discharging cannot be reduced because a distortion is formed in the five-membered ring itself or a distortion is formed in a six-membered ring adjacent to the five-membered ring.

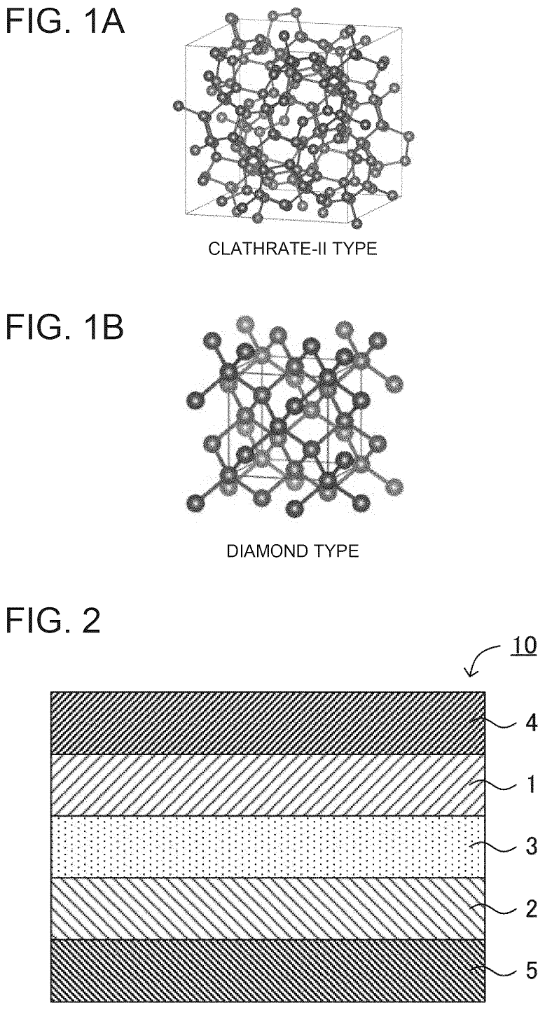

The electrode active material in the present disclosure has a silicon-clathrate-II-type crystal phase. As shown in FIG. 1A, in the silicon-clathrate-II-type crystal phase, a polyhedron (cage) including a pentagonal shape (five-membered ring) or a hexagonal shape (six-membered ring) is formed by a plurality of Si elements. This polyhedron has a space that can include metal ions such as Li ions on the inside thereof. The volume change due to charging and discharging can be reduced by inserting metal ions into the space. In particular, in an all-solid-state battery, a high confining pressure generally needs to be applied in order to reduce the volume change due to charging and discharging. However, by using the electrode active material in the present disclosure, the confining pressure can be reduced. As a result, the upsizing of a confining jig can be reduced. Meanwhile, as shown in FIG. 1B, a tetrahedron is formed by a plurality of Si elements in the diamond-type silicon crystal phase. The tetrahedron does not have a space that can include metal ions such as Li ions on the inside thereof. Therefore, the volume change due to charging and discharging is not easily reduced in the diamond-type silicon crystal phase as compared to the silicon-clathrate-II-type crystal phase. However, there are cases where the volume change due to charging and discharging can be reduced as a result of the electrode active material including a few diamond-type silicon crystal phases.

The electrode active material in the present disclosure has a silicon-clathrate-II-type crystal phase. The five-membered ring size of the silicon-clathrate-II-type crystal phase is normally 3.752 Å or more and 3.780 Å or less and may be 3.755 Å or more and 3.775 Å or less. The five-membered ring size is within a predetermined range, and hence an electrode active material of which volume change due to charging and discharging is small is obtained. The five-membered ring size is obtained by performing Rietveld analysis on XRD measurement results, generating a crystal model based on atom position information, and calculating each interatomic distance in the crystal model. Specifically, the maximum value of the length of a diagonal line of the five-membered ring is the five-membered ring size.

It is preferred that the electrode active material in the present disclosure have a silicon-clathrate-II-type crystal phase as a main phase. The “main phase” means that a peak belonging to that crystal phase has the greatest diffraction intensity out of peaks observed in the X-ray diffraction measurement. The rate of the silicon-clathrate-II-type crystal phases included in the electrode active material is 80 weight % or more and may be 85 weight % or more, may be 90 weight % or more, or may be 95 weight % or more, for example. The rate of the silicon-clathrate-II-type crystal phases included in the electrode active material may be 100 weight % or may be less than 100 weight %. The rate of the crystal phases can be obtained by performing Rietveld analysis on XRD measurement results and using the analytical result thereof and a reference intensity ratio method (RIR method).

The electrode active material in the present disclosure may have a silicon-clathrate-I-type crystal phase or may not have a silicon-clathrate-I-type crystal phase. The expression of “does not have a crystal phase” means that a peak of the crystal phase is not found in the X-ray diffraction measurement.

The electrode active material in the present disclosure may have a diamond-type silicon crystal phase or may not have a diamond-type silicon crystal phase. The rate of the diamond-type silicon crystal phases included in the electrode active material may be 0 weight %, may be more than 0 weight %, or may be 0.2 weight % or more, for example. Meanwhile, the rate of the diamond-type silicon crystal phases included in the electrode active material is 5 weight % or less and may be 3 weight % or less, for example.

The composition of the electrode active material in the present disclosure is not particularly limited, but is preferably expressed by NaₓSi_{1.36} (0≤x≤24). Here, x may be 0 or may be more than 0. Meanwhile, x may be 20 or less, may be 10 or less, or may be 5 or less. The composition of the electrode active material can be obtained by an EDX, an XRD, an XRF, an ICP, and an atomic absorption method, for example.

The electrode active material in the present disclosure may be a primary particle or may be a secondary particle obtained by aggregating primary particles. An average particle size (D₅₀) of the electrode active material is not particularly limited, but is 0.1 μm or more and 50 μm or less and may be 0.5 μm or more and 30 μm or less, for example. The average particle size (D₅₀) can be calculated from measurement by a scanning electron microscope (SEM), for example.

The electrode active material preferably has a gap on the inside of the primary particle. The gap rate is 4% or more and may be 10% or more, for example. The gap rate is 40% or less and may be 20% or less, for example. The gap rate can be obtained by a procedure as below, for example. First, section exposure of an electrode layer including the electrode active material is performed by ion milling. A photograph of particles is obtained by observing the section by the scanning electron microscope (SEM). Rigid distinction and binarization of a silicon portion and a gap portion are performed with use of image analysis software from the obtained photograph. The areas of the silicon portion and the gap portion are obtained, and a gap rate (%) is calculated from Expression below.

Gap rate (%)=100×(gap portion area)/((silicon portion area)+(gap portion area))

The electrode active material in the present disclosure is normally used in a battery. The electrode active material in the present disclosure may be a negative-electrode active material or may be a positive-electrode active material, but the former is preferred.

A method of manufacturing the electrode active material is not particularly limited, but preferably includes an alloying step of obtaining a Na—Si alloy by causing a Na source and a Si source to react with each other, and a burning step of generating a silicon-clathrate-II-type crystal phase by burning the Na—Si alloy and reducing a Na amount in the Na—Si alloy.

The alloying step is a step of obtaining a Na—Si alloy by causing a Na source and a Si source to react with each other. The Si source is single Si, for example. The Si source is preferably porous Si having many gaps on the inside of the primary particle. Meanwhile, the Na source at least contains Na. Examples of the Na source are metallic Na, NaH, and a metallic Na dispersing element in which particles of metallic Na are dispersed in oil.

Examples of a method of obtaining a Na—Si alloy by causing a Na source and a Si source to react with each other include a method of heating a mixture including a Na source and a Si source. The heating temperature is 300° C. or more and may be 310° C. or more, may be 320° C. or more, or may be 340° C. or more, for example. Meanwhile, the heating temperature is 800° C. or less and may be 600° C. or less or may be 450° C. or less, for example.

The Na—Si alloy preferably has a Zintl phase and preferably has the Zintl phase as a main phase. The composition of the Na—Si alloy is not particularly limited but is preferably expressed by a composition of Na_{z}Si_{1.36} (121≤z≤151).

The burning step is a step of generating a silicon-clathrate-II-type crystal phase by burning the Na—Si alloy and reducing the Na amount of the Na—Si alloy. In the burning step, the burning condition is preferably adjusted such that the five-membered ring size of the silicon-clathrate-II-type crystal phase becomes 3.752 Å or more and 3.780 Å or less.

There is a possibility that the five-membered ring size is correlated to the crystallite size of the silicon-clathrate-II-type crystal phase. The crystallite size can be controlled by adjusting the burning condition. Specifically, the crystallite size can be adjusted by taking the balance between nuclear generation and nuclear growth at the time of burning into consideration. The balance between nuclear generation and nuclear growth at the time of burning can be controlled by the burning temperature, for example. Here, burning at a temperature that is high to some extent is needed in order to form a silicon-clathrate-II-type crystal phase from the Zintl phase included in the Na—Si alloy. Specifically, the burning of the Na—Si alloy needs to be performed at a temperature of 340° C. or more. Meanwhile, when burning is performed at the temperature of 340° C. or more, the nuclear growth of the silicon-clathrate-II-type crystal phase is prioritized over the nuclear generation of the silicon-clathrate-II-type crystal phase, and hence the crystallite size of the silicon-clathrate-II-type crystal phase tends to be great. As a result, the five-membered ring size also tends to be great.

Meanwhile, by performing burning at a temperature less than 340° C. before performing burning at the temperature of 340° C. or more, nuclear generation is prioritized over nuclear growth, and the crystallite size can be caused to be smaller. As a result, the five-membered ring size also tends to be small. In other words, the burning step preferably includes at least first burning processing of burning the Na—Si alloy at a temperature less than 340° C., and second burning processing of burning, at a temperature of 340° C. or more, a compound on which the first burning processing has been performed.

The first burning processing is processing of burning the Na—Si alloy at a temperature less than 340° C. In the first burning processing, a scavenger described later may be used or may not be used. The burning temperature in the first burning processing is normally less than 340° C. and may be less than 310° C. or may be 300° C. or less. Meanwhile, the burning temperature in the first burning processing is 250° C. or more and may be 270° C. or more or may be 280° C. or more, for example. The amount of burning time in the first burning processing is one hour or more and 50 hours or less and may be five hours or more and 30 hours or less, for example.

The second burning processing is processing of burning, at a temperature of 340° C. or more, the compound on which the first burning processing has been performed. In the second burning processing, a scavenger described later is preferably used and it is especially preferred to use AlF₃. The burning temperature in the second burning processing is normally 340° C. or more and may be 360° C. or more. Meanwhile, the burning temperature in the second burning processing may be 450° C. or less, for example. The amount of burning time in the second burning processing is one hour or more and 120 hours or less and may be 10 hours or more and 80 hours or less, for example. The compound on which the second burning processing has been performed preferably has a silicon-clathrate-II-type crystal phase.

The burning step may have third burning processing of burning, at a temperature of 340° C. or more, the compound on which the second burning processing has been performed. In the third burning processing, a scavenger described later is preferably used and it is especially preferred to use ZnCl₂. The burning temperature in the third burning processing is normally 340° C. or more and may be 360° C. or more. Meanwhile, the burning temperature in the third burning processing may be 450° C. or less, for example. The amount of burning time in the third burning processing is one hour or more and 120 hours or less and may be 10 hours or more and 80 hours or less, for example. The compound on which the third burning processing has been performed preferably has a silicon-clathrate-II-type crystal phase as a main phase.

In the burning step, a scavenger that captures Na in the Na—Si alloy is preferably used. One example of the scavenger is a Na getter agent that reacts with vapor of Na generated from the Na—Si alloy. The Na getter agent is disposed in a state of not being in contact with the Na—Si alloy, for example. Examples of the Na getter agent include SiO, MoO₃, FeO, and Fc₃O₄. When the Na getter agent is used, the burning step is preferably performed in a reduced-pressure atmosphere.

Another example of the scavenger is a Na trap agent that receives Na by directly reacting with the Na—Si alloy. The Na trap agent is disposed in a state of being in contact with the Na—Si alloy, for example. Examples of the Na trap agent include CaCl₂), AlF₃, CaBr₂, Cal₂, Fc₃O₄, FcO, MgCl₂, ZnO, ZnCl₂, and MnCl₂. When the Na trap agent is used, the burning step may be performed in a reduced-pressure atmosphere or may be performed in a normal-pressure atmosphere.

The balance between nuclear generation and nuclear growth at the time of burning can be controlled by the type, the particle size, and the additive amount of the scavenger, for example. For example, the contact area between the Na trap agent and the Na—Si alloy increases by reducing the particle size of the Na trap agent that is the scavenger. As a result, Na is easily extracted from the Na—Si alloy, nuclear generation is prioritized over nuclear growth, and the crystallite size can be adjusted to be small. Meanwhile, it is assumed that a diamond-type silicon crystal phase, which is more stable than a silicon-clathrate-II-type crystal phase, is easily generated when the contact area between the Na trap agent and the Na—Si alloy increases too much.

### B. Electrode Mixture

The electrode mixture in the present disclosure contains the electrode active material described above and at least one of the conductive material and the binder.

According to the present disclosure, an electrode mixture of which volume change due to charging and discharging is small is obtained by using the electrode active material described above.

The electrode mixture contains the electrode active material and at least one of the conductive material and the binder. The electrode active material is similar to that in the content described in the above “A. Electrode Active Material”. The electrode active material may be a negative-electrode active material or may be a positive-electrode active material, but the former is preferred. In other words, the electrode mixture may be a negative-electrode mixture or a positive-electrode mixture, but the former is preferred.

The rate of the electrode active material in the electrode mixture is 20 weight % or more and may be 30 weight % or more or may be 40 weight % or more, for example. When the rate of the electrode active material is too small, there is a possibility that sufficient energy density cannot be obtained. Meanwhile, the rate of the electrode active material is 80 weight % or less and may be 70 weight % or less or may be 60 weight % or less, for example. When the rate of the electrode active material is too great, there is a possibility that the ionic conductivity and the electronic conductivity in the electrode mixture relatively decrease.

The electrode mixture contains at least one of the conductive material and the binder. Examples of the conductive material include a carbon material, metallic particles, and a conductive polymer. Examples of the carbon material include particulate carbon materials such as acetylene black (AB) and ketjen black (KB) and fibrous carbon materials such as the carbon fiber, a carbon nanotube (CNT), and carbon nanofiber (CNF). Examples of the binder include a rubber-based binder and a fluorine-based binder.

The electrode mixture may further contain solid electrolyte. Examples of the solid electrolyte include inorganic solid electrolytes such as a sulfide solid electrolyte, an oxide solid electrolyte, a nitride solid electrolyte, and a halide solid electrolyte, and organic polyelectrolytes such as a polymer electrolyte. Examples of the sulfide solid electrolyte include a solid electrolyte containing a Li element, an X element (X is at least one type of P, As, Sb, Si, Ge, Sn, B, Al, Ga, and In), and a S element. The sulfide solid electrolyte may further contain at least one of an O element and a halogen element. Examples of the halogen element include a F element, a Cl element, a Br element, and an I element. The sulfide solid electrolyte may be glass (amorphous) or may be glass ceramics. Examples of the sulfide solid electrolyte include Li₂S—P₂S₅, LiI—Li₂S—P₂S₅, LiI—LiBr—Li₂S—P₂S₅, Li₂S—SiS₂, Li₂S—GeS₂, and Li₂S—P₂S₂—GeS₂. The electrode mixture may further contain a dispersion medium.

Examples of the method of manufacturing an electrode mixture include a method of mixing the electrode active material and at least one of the conductive material and the binder.

### C. Battery

FIG. 2 is a schematic sectional view exemplifying a battery in the present disclosure. A battery 10 shown in FIG. 2 includes a positive-electrode layer 1, a negative-electrode layer 2, an electrolyte layer 3 disposed between the positive-electrode layer 1 and the negative-electrode layer 2, a positive-electrode current collector 4 that performs current collection of the positive-electrode layer 1, and a negative-electrode current collector 5 that performs current collection of the negative-electrode layer 2. In the present disclosure, the positive-electrode layer 1 or the negative-electrode layer 2 contains the electrode mixture described in the above “B. Electrode Mixture”.

According to the present disclosure, a battery of which volume change due to charging and discharging is small is obtained by using the electrode mixture described above. As described above, the electrode mixture may be a negative-electrode mixture or may be a positive-electrode mixture, but the former is preferred. The battery is described below in detail for a case where the electrode mixture is a negative-electrode mixture.

### 1. Negative-Electrode Layer

The negative-electrode layer in the present disclosure contains the electrode mixture (negative-electrode mixture) described above. The electrode mixture is similar to that in the content described in the above “B. Electrode Mixture”, and hence description is omitted here. The negative-electrode layer may contain an electrolyte as needed. The electrolyte is similar to that in the content described in “3. Electrolyte Layer”. The thickness of the negative-electrode layer is 0.1 μm or more and 1000 μm or less and may be 0.1 μm or more and 500 μm or less or may be 0.1 μm or more and 100 μm or less, for example. Examples of a method of forming a negative-electrode layer include a method of coating the negative-electrode current collector with the electrode mixture (negative-electrode mixture).

### 2. Positive-Electrode Layer

The positive-electrode layer is a layer that contains at least the positive-electrode active material. The positive-electrode layer may contain at least one of the electrolyte, the conductive material, and the binder as needed.

Examples of the positive-electrode active material include an oxide active material. Examples of the oxide active material include rock-salt-layer active materials such as LiCoO₂, LiMnO₂, LiNiO₂, LiVO₂, and LiNi_{1/3}CO_{1/3}Mn_{1/3}O₂, spinel active materials such as LiMn₂O₄, Li₄Ti₅O₁₂, and Li(Ni_{0.5}Mn_{1.5})O₄, and LiFePO₄, and olivine active materials such as LiMnPO₄, LiNiPO₄, and LiCoPO₄.

In a front surface of the oxide active material, a coat layer that contains a Li ion conductive oxide active material may be formed. This is because the reaction between the oxide active material and the solid electrolyte (in particular, the sulfide solid electrolyte) can be reduced. Examples of the Li ion conductive oxide include LiNbO₃. The thickness of the coat layer is 1 nm or more and 30 nm or less, for example. As the positive-electrode active material, Li₂S can be used, for example.

The electrolyte used in the positive-electrode layer is similar to that in the content described in “3. Electrolyte Layer”. The conductive material and the binder used in the positive-electrode layer are similar to those in the content described in the above “B. Electrode Mixture”, and hence description is omitted here. The thickness of the positive-electrode layer is 0.1 μm or more and 1000 μm or less and may be 0.1 μm or more and 500 μm or less or may be 0.1 μm or more and 100 μm or less, for example.

### 3. Electrolyte Layer

The electrolyte layer is a layer formed between the positive-electrode layer and the negative-electrode layer and contains at least an electrolyte. The electrolyte may be a solid electrolyte or may be a liquid electrolyte (electrolytic solution).

The solid electrolyte is similar to that in the content described in the above “B. Electrode Mixture”, and hence description is omitted here. Meanwhile, the electrolytic solution preferably contains supporting salt and a solvent. A well-known electrolytic solution can be used as the electrolytic solution. The thickness of the electrolyte layer is 0.1 μm or more and 1000 μm or less and may be 0.1 μm or more and 500 μm or less or may be 0.1 μm or more and 100 μm or less, for example.

### 4. Other Configurations

The battery in the present disclosure preferably includes a positive-electrode current collector that performs current collection of the positive-electrode layer and a negative-electrode current collector that performs current collection of the negative-electrode layer. Examples of the material of the positive-electrode current collector include SUS, aluminum, nickel, iron, titanium and carbon. Meanwhile, examples of the material of the negative-electrode current collector include SUS, nickel, and carbon.

The battery in the present disclosure may further include a confining jig that applies a confining pressure to the positive-electrode layer, the electrolyte layer, and the negative-electrode layer along the thickness direction. In particular, when the electrolyte layer is a solid electrolyte layer, it is preferred to apply a confining pressure in order to form a satisfactory ion conduction path and electron conduction path. The confining pressure is 0.1 MPa or more and may be 1 MPa or more or may be 5 MPa or more, for example. Meanwhile, the confining pressure is 100 MPa or less and may be 50 MPa or less or may be 20 MPa or less, for example.

### 5. Battery

The type of the battery in the present disclosure is not particularly limited, but it is typically a lithium ion battery. The battery in the present disclosure may be a liquid battery that contains an electrolytic solution as an electrolyte layer or may be an all-solid-state battery that has a solid electrolyte layer as an electrolyte layer. The battery in the present disclosure may be a primary battery or may be a secondary battery, but it is especially preferred that the battery be a secondary battery. This is because the secondary battery can be repeatedly charged and discharged and is useful as an in-vehicle battery, for example.

Examples of the usage of the battery include a power source of vehicles such as a hybrid electric vehicle (HEV), a plug-in hybrid electric vehicle (PHEV), a battery electric vehicle (BEV), a gasoline vehicle, and a diesel vehicle. In particular, the battery is preferably used as a driving power source of a hybrid electric vehicle (HEV), a plug-in hybrid electric vehicle (PHEV), or a battery electric vehicle (BEV). The battery may be used as a power source of a mobile body (for example, a railroad, a ship, and an aircraft) other than a vehicle, or may be used as a power source of an electric appliance such as an information processing apparatus. The method of producing the battery is not particularly limited, and a well-known method can be employed.

The present disclosure is not limited to the embodiment. The embodiment is an exemplification, and anything that has substantially the same technical idea as that described in the claims of the present disclosure and exhibits similar effects is included in the technical scope of the present disclosure.

### Example 1

A Li—Si alloy having a Li₁₅Si₄ phase was obtained by weighing metallic Li and Si powder (manufactured by Kojundo Chemical Laboratory Co., Ltd., SIEPB32) at a mole ratio of 4:1 under an Ar atmosphere and mixing the metallic Li and the Si powder in a mortar for one hour. The obtained Li—Si alloy was caused to react with ethanol under an Ar atmosphere. Then, acetic acid was added, and liquid components and solid components were separated from each other by filtration. Powdered porous Si was obtained by vacuum drying the separated solid components at 120° C.

The obtained porous Si and NaH that is a Na source were weighed such that a mole ratio of NaH/porous Si=1.1/1 was obtained, and were mixed using a cutter mill. A Na—Si alloy was obtained by placing the obtained mixture into a reaction vessel and burning the obtained mixture with a condition of an Ar atmosphere, 475° C., and 10 hours.

The obtained Na—Si alloy and AlF₃ that is a Na trap agent were mixed. AlF₃ that was classified with use of a sieve with a mesh size of 35 μm and a sieve with a mesh size of 75 μm was used. The first burning processing was performed on the obtained mixture with a condition of an Ar atmosphere, 290° C., and 10 hours, and then the second burning processing was performed on the obtained mixture with a condition of an Ar atmosphere, 340° C., and 40 hours. Then, the obtained compound was put into a HNO₃ solution with a concentration of 6 weight % and was stirred for one hour. Then, the stirred compound was filtered, the solid content was dried with a condition of 120° C. and 12 hours, and powder was obtained.

The obtained powder and zinc chloride (ZnCl₂) were weighed such that a mole ratio of powder:ZnCl₂=6:1 was obtained, and were mixed using a cutter mill. The third burning processing of the obtained mixture was performed with a condition of an Ar atmosphere, 345° C., and 15 hours. Then, the obtained compound was put into a HNO₃ solution with a concentration of 6 weight % and was stirred for one hour. Then, the stirred compound was filtered, the solid content was dried with a condition of 120° C. and 12 hours, and powder was obtained.

The obtained powder was put into a hydrogen fluoride (HF) solution with a concentration of 3 weight % and was stirred for three hours. Then, the stirred compound was sucked and filtered, the solid content was dried with a condition of 120° C. and 12 hours, and powder was obtained. After the drying, the obtained powder was put into acetone, coarse powder was removed with use of a sieve made of resin, and an electrode active material was obtained.

### Example 2

An electrode active material was obtained in a manner similar to Example 1 other than performing the second burning processing with a condition of an Ar atmosphere, 340° C., and 80 hours.

### Example 3

An electrode active material was obtained in a manner similar to Example 1 other than performing the second burning processing with a condition of an Ar atmosphere, 340° C., and 60 hours.

### Example 4

The first burning processing was performed with a condition of an Ar atmosphere, 280° C., and 10 hours, and an electrode active material was obtained in a manner similar to Example 1 other than performing the second burning processing with a condition of an Ar atmosphere, 340° C., and 20 hours.

### Example 5

The first burning processing was performed with a condition of an Ar atmosphere, 280° C., and 10 hours, and an electrode active material was obtained in a manner similar to Example 1 other than performing the second burning processing with a condition of an Ar atmosphere, 340° C., and 100 hours.

### Comparative Example 1

The first burning processing was performed with a condition of an Ar atmosphere, 340° C., and 10 hours, and an electrode active material was obtained in a manner similar to Example 1 other than performing the second burning processing with a condition of an Ar atmosphere, 340° C., and 120 hours.

### Comparative Example 2

AlF₃ was placed into a vessel with crushing balls ($1 μm), and atomization was performed with a condition of 200 rpm and three hours with use of a planetary ball mill (FRITSCH). With use of the atomized AlF₃, the first burning processing was performed with a condition of an Ar atmosphere, 310° C., and 10 hours, and an electrode active material was obtained in a manner similar to Example 1 other than performing the second burning processing with a condition of an Ar atmosphere, 340° C., and 10 hours.

### Comparative Example 3

The first burning processing was performed with a condition of an Ar atmosphere, 360° C., and 10 hours, and an electrode active material was obtained in a manner similar to Example 1 other than performing the second burning processing with a condition of an Ar atmosphere, 360° C., and 100 hours.

### Evaluation

### XRD Measurement

X-ray diffraction (XRD) measurement using CuKα radiation was performed on the electrode active materials obtained in Examples 1 to 5 and Comparative Examples 1 to 3. As a result, it was confirmed that all of the electrode active materials had a silicon-clathrate-II-type crystal phase as a main phase.

The intensity of a peak A positioned near 20=20.09° was represented by IA, and the intensity of a peak B positioned near 20=31.72° was represented by IB in the silicon-clathrate-II-type crystal phase. The maximum intensity at 20=22° to 23° was represented by IM, and IA/IM and IB/IM were obtained. As a result, in all of the electrode active materials obtained in Examples 1 to 5 and Comparative Examples 1 to 3, IA/IM was greater than 1, and IB/IM was also greater than 1.

Rietveld analysis was performed with use of XRD analysis software (PDXL manufactured by Rigaku Corporation). Further, a crystal model based on atom position information was generated, each interatomic distance in the crystal model was calculated, and the maximum value of the length of a diagonal line of the five-membered ring was set to be the five-membered ring size of the silicon-clathrate-II-type crystal phase. The result is shown in Table 1. All of the electrode active materials obtained in Examples 1 to 5 and Comparative Examples 1 to 3 had a few diamond-type silicon crystal phases. The rate (crystalline Si amount) of the diamond-type silicon crystal phases was obtained with use of an analysis result of the Rietveld analysis and the RIR method. The result is shown in Table 1.

### SEM Observation

Average particle sizes (D₅₀) of the electrode active materials obtained in Examples 1 to 5 and Comparative Examples 1 to 3 was obtained by observation by a scanning electron microscope (SEM). As a result, the average particle size D₅₀ was about 1 μm in all of the electrode active materials. As above, the average particle size (D₅₀) of the electrode active material was preferred to be 0.5 μm or more and 5 μm or less.

### Measurement of Volumetric Expansion Rate

All-solid-state batteries were manufactured by using the electrode active materials obtained in Examples 1 to 5 and Comparative Examples 1 to 3 as negative-electrode active materials. The manufacturing method was as follows.

### (1) Manufacturing of Negative Electrode

The obtained electrode active material, a sulfide solid electrolyte (Li₂S—P₂S₅-based glass ceramic), a conductive material (VGCF), a butyl butyrate solution containing a PVDF-based binder at a rate of 5 weight %, and butyl butyrate were added into a vessel made of polypropylene, and were stirred by an ultrasonic dispersion apparatus (UH-50 manufactured by SMT Co., Ltd.) for 30 seconds. Next, the vessel was shaken by a shaker (manufactured by SIBATA SCIENTIFIC TECHNOLOGY LTD., TTM-1) for 30 minutes. Coating was applied to a negative-electrode current collector (a Cu foil, manufactured by UACJ Corporation) by a blade method with use of an applicator, and drying was performed on a hot plate at 100° C. for 30 minutes. As a result, a negative electrode having a negative-electrode current collector and a negative-electrode layer was obtained.

### (2) Manufacturing of Positive Electrode

The positive-electrode active material (LiNi_{1/3}Co_{1/3}Mn_{1/3}O₂, an average particle size of 6 μm), a sulfide solid electrolyte (Li₂S—P₂S₅-based glass ceramic), a conductive material (VGCF), a butyl butyrate solution containing a PVDF-based binder at a rate of 5 weight %, and butyl butyrate were added into a vessel made of polypropylene, and were stirred by an ultrasonic dispersion apparatus (UH-50 manufactured by SMT Co., Ltd.) for 30 seconds. Next, the vessel was shaken by a shaker (manufactured by SIBATA SCIENTIFIC TECHNOLOGY LTD., TTM-1) for three minutes, stirred by the ultrasonic dispersion apparatus for 30 seconds, and shaken by the shaker for three minutes. Coating was applied to a positive-electrode current collector (an Al foil, manufactured by Showa Denko K.K.) by a blade method with use of an applicator, and drying was performed on a hot plate at 100° C. for 30 minutes. As a result, a positive electrode having a positive-electrode current collector and a positive-electrode layer was obtained. The area of the positive electrode was set to be smaller the area of the negative electrode.

### (3) Manufacturing of Solid Electrolyte Layer

A sulfide solid electrolyte (Li₂S—P₂S₅-based glass ceramic), a heptane solution containing a butylene-rubber-based binder at a rate of 5 weight %, and heptane were added into a vessel made of polypropylene, and were stirred by an ultrasonic dispersion apparatus (UH-50 manufactured by SMT Co., Ltd.) for 30 seconds. Next, the vessel was shaken by a shaker (manufactured by SIBATA SCIENTIFIC TECHNOLOGY LTD., TTM-1) for 30 minutes. Coating was applied to a releasing sheet (Al foil) by a blade method with use of an applicator, and drying was performed on a hot plate at 100° C. for 30 minutes. As a result, a transfer member having a releasing sheet and a solid electrolyte layer was obtained.

(4) Manufacturing of all-Solid-State Battery

A solid electrolyte layer for joining was disposed on the positive-electrode layer in the positive electrode, setting in a roll press machine was performed, and pressing was performed at 100 kN/cm and 165° C. As a result, a first laminated body was obtained.

Next, the negative electrode was set in the roll press machine and was pressed at 60 kN/cm and 25° C. As a result, a pressed negative electrode was obtained. Then, the solid electrolyte layer for joining and the transfer member were disposed in the order from the negative-electrode layer side. At this time, the solid electrolyte layer for joining and the solid electrolyte layer in the transfer member were disposed to face each other. The obtained laminated body was set in a flat uniaxial press machine and was temporarily pressed at 100 MPa and 25° C. for 10 seconds. Then, the releasing sheet was peeled off from the solid electrolyte layer. As a result, a second laminated body was obtained.

Next, the solid electrolyte layer for joining in the first laminated body and the solid electrolyte layer in the second laminated body were disposed to face each other, set in the flat uniaxial press machine, and pressed at 200 MPa and 120° C. for one minute. As a result, an all-solid-state battery was obtained.

### (5) Measurement of Volumetric Expansion Rate

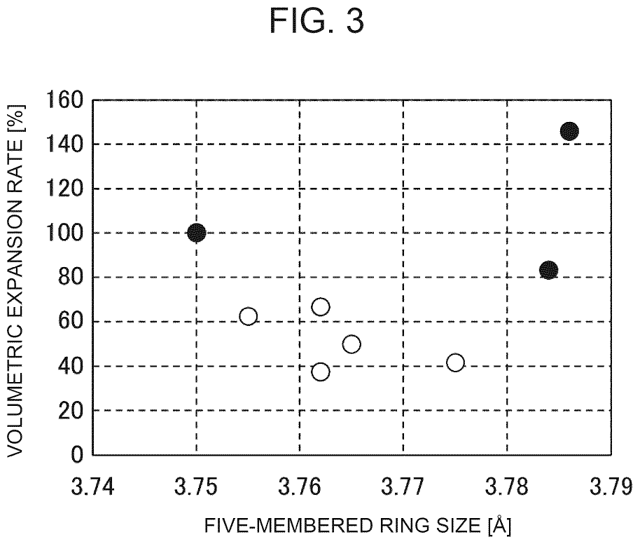

The obtained all-solid-state battery was charged and the volumetric expansion rate was measured. The test condition was a confining pressure (fixed size) of 5 MPa, charging of 0.1 C, and cut voltage of 4.55 V. The confining pressure at 4.55 V was measured, a confining pressure increase amount from a state before charging was obtained, and a volumetric expansion rate was obtained. The result is shown in Table 1 and FIG. 3. The result of the volumetric expansion rate in Table 1 and FIG. 3 is a relative value considering that the result of Comparative Example 1 is 100.

TABLE 1

| | Crystalline Si | Five-membered | Volumetric |
|---|---|---|---|
| | amount (wt %) | ring size (Å) | expansion rate (%) |
| Comparative | 0.81 | 3.750 | 100 |
| Example 1 | | | |
| Comparative | 3.0 | 3.784 | 83.3 |
| Example 2 | | | |
| Comparative | 0.8 | 3.786 | 145.8 |
| Example 3 | | | |
| Example 1 | 0.53 | 3.765 | 50.0 |
| Example 2 | 0.41 | 3.755 | 62.5 |
| Example 3 | 0.8 | 3.762 | 37.5 |
| Example 4 | 0.7 | 3.775 | 41.7 |
| Example 5 | 1.0 | 3.762 | 66.7 |

As shown in Table 1, in Example 3 and Comparative Example 1, the crystalline Si amounts were about the same, but there was a great difference in the volumetric expansion rate. As shown in Table 1 and FIG. 3, in Examples 1 to 5, it was confirmed that the volumetric expansion rate becomes smaller as compared to Comparative Examples 1 to 3. As above, the volumetric expansion rate was reduced because the five-membered ring size was in a predetermined range.

What is claimed is:

1. An electrode active material having a silicon-clathrate-II-type crystal phase, wherein a five-membered ring size in the crystal phase is 3.752 Å or more and 3.780 Å or less.

2. The electrode active material according to claim 1, wherein the electrode active material has a gap on an inside of a primary particle.

3. An electrode mixture containing:
an electrode active material according to claim 1; and
at least one of a conductive material or a binder.

4. A battery, comprising:
a positive-electrode layer;
a negative-electrode layer; and
an electrolyte layer disposed between the positive-electrode layer and the negative-electrode layer, wherein the positive-electrode layer or the negative-electrode layer contains the electrode mixture according to claim 3.

5. The battery according to claim 4, wherein the electrolyte layer contains a solid electrolyte.
